(19) United States
(12) Patent Application Publication
(10) Pub. No.: US 2014/0134593 A1
(43) Pub. Date: May 15, 2014

(54) COMPUTERIZED DEVICE AND PARTS ASSEMBLY DIRECTION METHOD

(71) Applicant: HON HAI PRECISION INDUSTRY CO., LTD., NEW TAIPEI (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/050,353

(22) Filed: Oct. 10, 2013

(30) Foreign Application Priority Data
Nov. 15, 2012 (TW) 101142710

(51) Int. Cl. G09B 5/02

(52) U.S. Cl. CPC G09B 5/02
USPC 434/428

(57) ABSTRACT

A parts assembly direction method stores sample images of parts and instructions for assembly of the parts in a storage device of an assembly table. When the assembly table receives the parts, a camera captures a real-time image of the assembly table, and the method determines if the real-time image of the assembly table contains images of the parts. If the real-time image of the assembly table contains images of the parts, the method determines whether the parts are qualified by comparing the images of the parts with the sample images of the parts. If the parts are unqualified, the method displays prompt information on a screen of the assembly table to alert users that the parts are unqualified. Otherwise, if the parts are qualified, the method displays the real-time image of the assembly table and the instructions for assembly of the parts on the screen.

### BACKGROUND

1. Technical Field

Embodiments of the present disclosure relate to information direction systems and methods, and particularly to a computerized device and a parts assembly direction method.

2. Description of Related Art

A production line is a set of sequential operations established in a factory whereby materials are put through a refining process to produce an end-product, which is suitable for onward consumption or components/parts are assembled to make a finished article. At present, most of the operations on the production line are automatically done by robots. However, complex operations are still done manually. Workers that take charge of the complex operations should be trained to learn skills of identifying whether the parts to be assembled are qualified and sequences of assembling the parts. Nonetheless, manual operations are still liable to cause errors.

### BRIEF DESCRIPTION OF THE DRAWINGS

FIG. 1 is a block diagram of one embodiment of an application environment of a parts assembly direction system.

FIG. 2 illustrates sample images of parts.

FIG. 3 illustrates real-time images of the parts located on different workstations of a production line and instructions for assembly of the parts.

FIG. 4 illustrates a block diagram of one embodiment of function module of the parts assembly direction system.

FIG. 5 is a flowchart of one embodiment of a parts assembly direction method.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

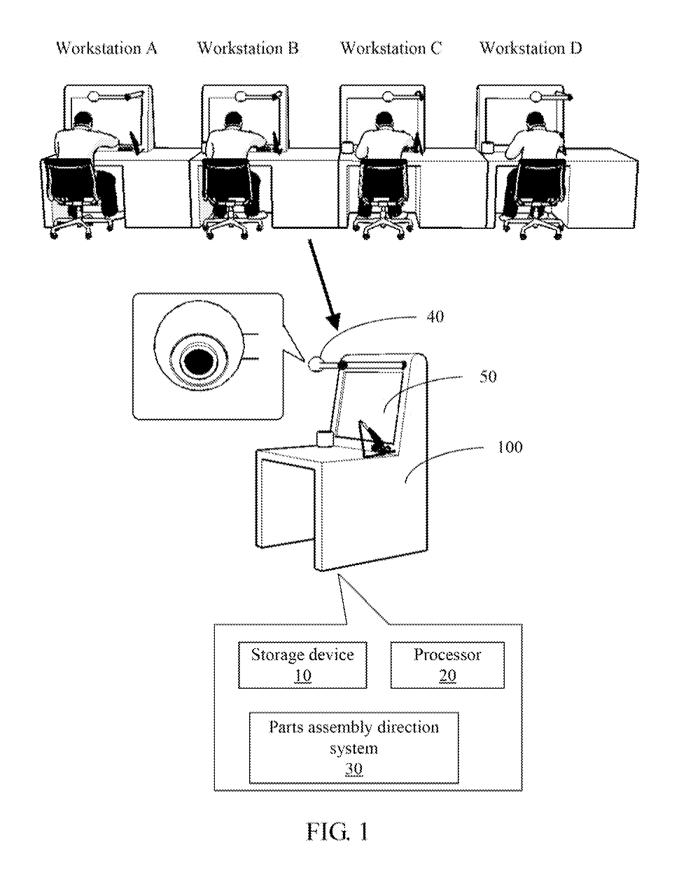

FIG. 1 is a block diagram of one embodiment of an application environment of a parts assembly direction system 30 (hereinafter the system 30). The parts assembly direction system 30 can be installed in assembling tables 100 of production lines. As shown in FIG. 1, a production line includes a plurality of workstations (e.g., workstation A-D), and each workstation includes at least one assembly table 100 installed with the system 30. The assembly table 100 further includes a storage device 10, a processor 20, a camera 40, and a screen 50.

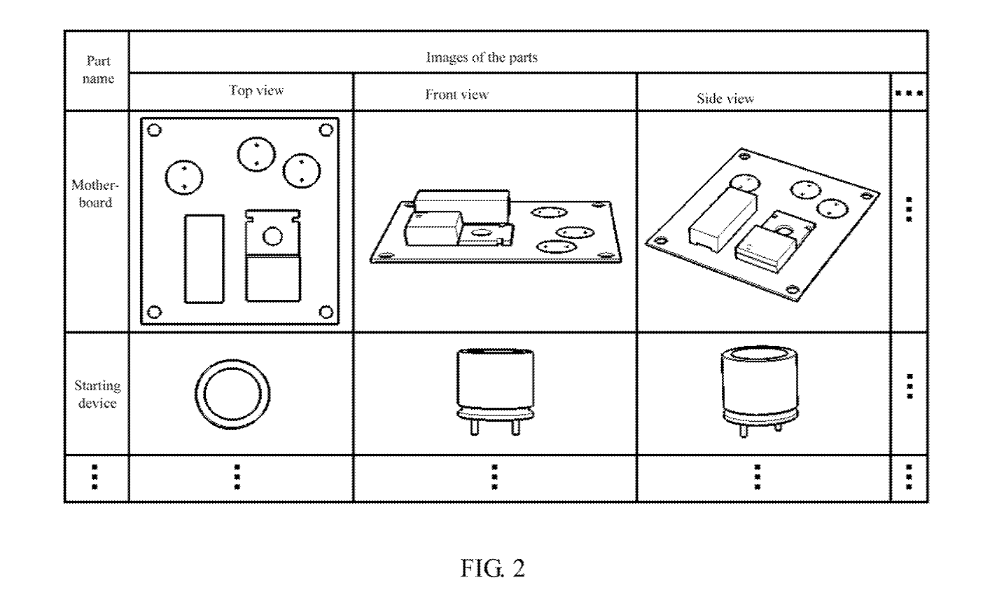

The storage device 10 stores sample images of parts and instructions for assembly of the parts. The parts include main parts and small parts. For example, a main part of a computer is a motherboard, and small parts of the computer include memory sticks, fans, display cards, a central processing unit, and hard disks, for example. FIG. 2 shows that the sample images of the parts (e.g., a motherboard and a starting device) may include different projection views, such as a top view, a front view, and a side view, of the parts.

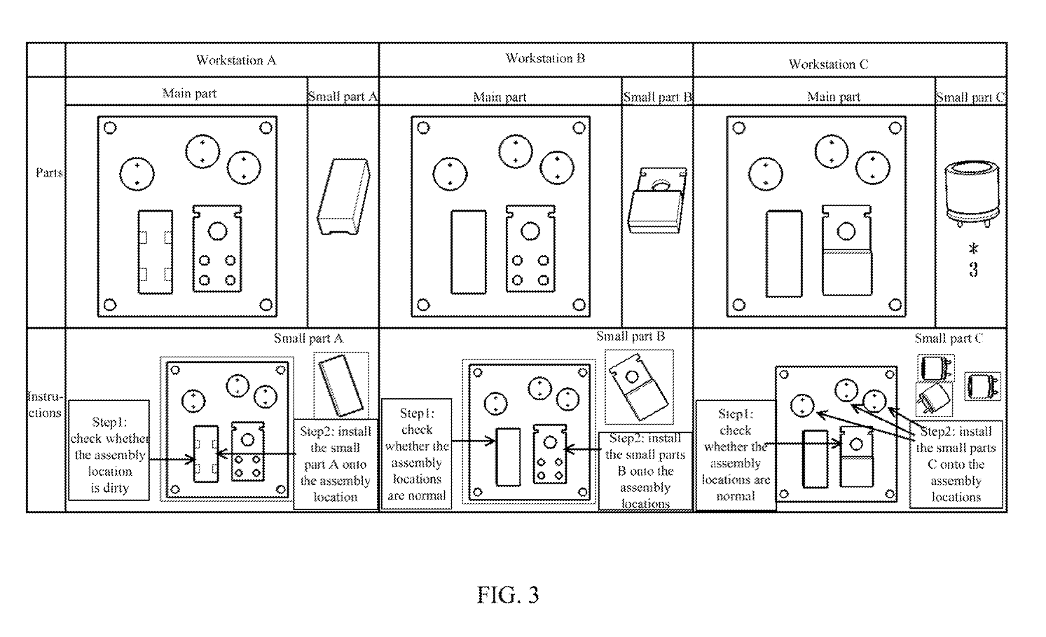

FIG. 3 illustrates top views of the motherboard (as shown in FIG. 2) and the small parts, which are transferred to the workstations A, B, and C at different times and prepared for assembly at the workstations A, B, and C. FIG. 3 also illustrates instructions for assembly of the motherboard the small parts in relation to the workstations A, B, and C. The instructions may include rules for assembling the parts, steps for assembling the parts, and indications for assembly locations of the parts in each step, for example.

The camera 40 of each assembly table 100 captures the sample images of the parts, and captures real-images of the assembly table 100 when the assembly table 100 receives the parts, which are transferred from a parts storehouse or other workstations (e.g., a previous workstation). The sample images of the parts and the real-time images of the assembly table 100 are captured by the camera 40 and are stored in the storage device 10.

The screen 50 of each assembly table 100 may display the sample images of the parts, the real-time images of the assembly table 100, and the instructions for assembly of the parts.

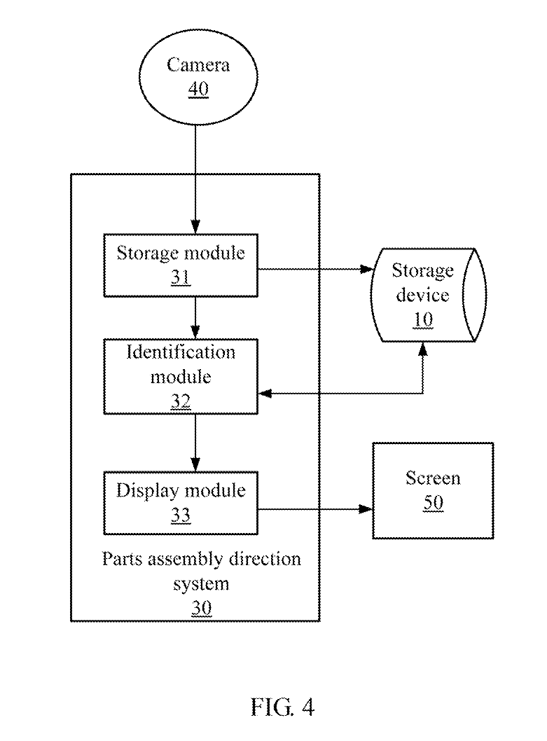

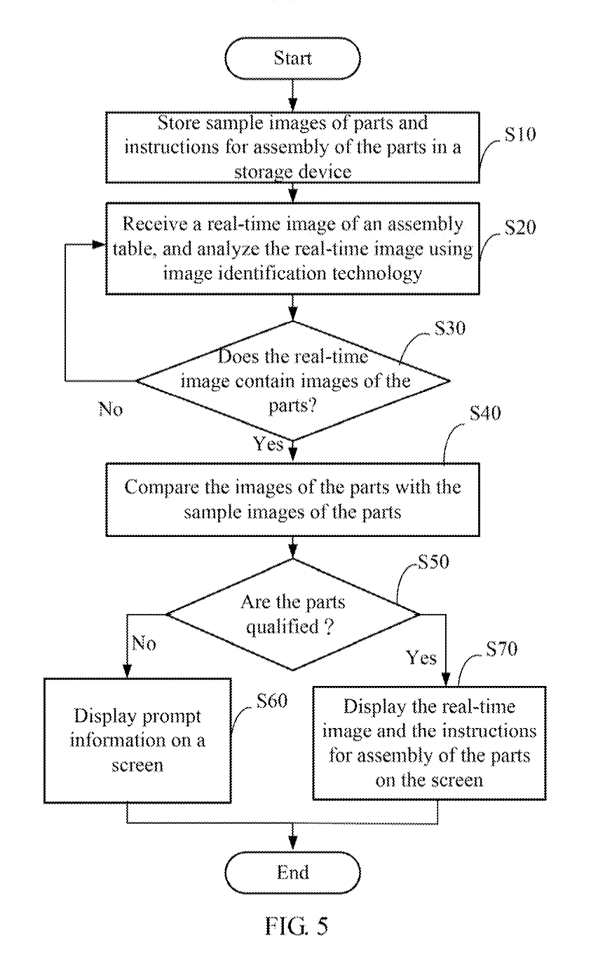

As shown in FIG. 4, the system 30 includes a storage module 31, an identification module 32, and a display module 33. The modules 31-33 include computerized code in the form of one or more programs. Computerized code of the modules 31-33 is stored in the storage device 10, the processor 20 executes the computerized code, to recognize images of the parts from the real-time images of the assembly table 100 using image identification technology, determine whether the parts are qualified by comparing the recognized images of the parts with the sample images of the parts, and display the real-time images of the assembly table 100 and the instructions for assembly of the parts on the screen 50 if the parts are qualified, or display prompt information on the screen 50 to alert users that the parts are unqualified. A detailed description of the modules 31-33 is given in reference to FIG. 5.

FIG. 5 is a flowchart of one embodiment of a parts assembly direction method. Depending on the embodiment, additional steps may be added, others removed, and the ordering of the steps may be changed.

In step S10, the storage module 31 stores sample images of the parts and instructions for assembly of the parts. As mentioned above, as shown in FIG. 2, the sample images of the parts may include different projection views, such as a top view, a front view, and a side view, of the parts. The instructions for assembly of the parts may include rules for assembling the parts, steps for assembling the parts, and indications for assembly locations of the parts in each step. For example, arrows shown in FIG. 3 indicate assembly locations of the parts A, B, C in each step.

In step S20, the camera 40 captures a real-time image of the assembly table 100 when the assembly table 100 receives the parts, which may be transferred from a parts storehouse or other workstations. The identification module 32 analyzes the real-time image using image identification technology, such as optimal character recognition (OCR) technology.

In step S30, the identification module 32 determines if the real-time image of the assembly table 100 includes images of the parts according to the analysis result. If the real-time image of the assembly table 100 does not include images of the parts, the procedure returns to step S20. If the real-time image of the assembly table 100 includes images of the parts, the identification module 32 further identifies locations of the parts on the assembly table 100, and then the procedure goes to step S40.

In step S40, the identification module 32 compares the images of the parts identified from the real-time image of the assembly table 100 with the sample images of the parts. For example, the identification module 32 checks if a profile of a part in the real-time image of the assembly table is the same as a profile of the part in a sample image.

In step S50, the identification module 32 determines whether the parts received by the assembly table 100 are qualified according to the check result. If the parts received by the assembly table 100 are unqualified, in step S60, the display module 33 displays prompt information on the screen 50 of the assembly table 100, to alert users that the parts received by the assembly table 100 are unqualified. If the parts received by the assembly table 100 are qualified, in step S60, the display module 33 displays real-time images of the assembly table 100 and the instructions for assembly of the parts on the screen 50, to direct the users to assemble the parts (as shown in FIG. 3).

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A parts assembly direction method being executed by a processor of an assembly table of a workstation, the method comprising:
storing sample images of parts and instructions for assembly of the parts in a storage device;
receiving a real-time image of the assembly table captured by a camera when the assembly table receives the parts from a defined workstation location;
determining if the real-time image of the assembly table contains images of the parts by analyzing the real-time image using image identification technology;
in response to determining the real-time image of the assembly table contains images of the parts, determining whether the parts are qualified by comparing the images of the parts identified from the real-time image of the assembly table with the sample images of the parts; and
displaying prompt information on a screen of the assembly table to alert users that the parts received by the assembly table are unqualified in response to determining the parts are unqualified, or displaying the real-time image of the assembly table and the instructions for assembly of the parts on the screen in response to determining the parts are qualified.

2. The method as claimed in claim 1, wherein the sample image of a part comprises one or more projection views of the part.

3. The method as claimed in claim 1, wherein the instructions for assembly of the parts comprise rules for assembling the parts, steps for assembling the parts, and indications for assembly locations of the parts in each step.

4. The method as claimed in claim 1, wherein determining whether a part is qualified is achieved by determining if a profile of the part in the real-time image of the assembly table is the same as a profile of the part in a sample image.

5. A computerized device, comprising:
a processor;
a storage device that stores one or more programs, when executed by the processor, causing the processor to perform operations:
storing sample images of parts and instructions for assembly of the parts in the storage device;
receiving a real-time image of the assembly table captured by a camera when the assembly table receives the parts from a defined workstation location;
determining if the real-time image of the assembly table contains images of the parts by analyzing the real-time image using image identification technology;
in response to determining the real-time image of the assembly table contains images of the parts, determining whether the parts are qualified by comparing the images of the parts identified from the real-time image of the assembly table with the sample images of the parts; and
displaying prompt information on a screen of the assembly table to alert users that the parts received by the assembly table are unqualified in response to determining the parts are unqualified, or displaying the real-time image of the assembly table and the instructions for assembly of the parts on the screen in response to determining the parts are qualified.

6. The system as claimed in claim 5, wherein the sample image of a part comprises one or more projection views of the part.

7. The system as claimed in claim 5, wherein the instructions for assembly of the parts comprise rules for assembling the parts, steps for assembling the parts, and indications for assembly locations of the parts in each step.

8. The system as claimed in claim 5, wherein determining whether a part is qualified is achieved by determining if a profile of the part in the real-time image of the assembly table is same as a profile of the part in a sample image.

9. A non-transitory computer-readable medium having stored thereon instructions that, when executed by a processor of an assembly table, causing the assembly table to perform operations:
storing sample images of parts and instructions for assembly of the parts in a storage device;
receiving a real-time image of the assembly table captured by a camera when the assembly table receives the parts from a defined workstation location;
determining if the real-time image of the assembly table contains images of the parts by analyzing the real-time image using image identification technology;
in response to determining the real-time image of the assembly table contains images of the parts, determining whether the parts are qualified by comparing the images of the parts identified from the real-time image of the assembly table with the sample images of the parts; and
displaying prompt information on a screen of the assembly table to alert users that the parts received by the assembly table are unqualified in response to determining the parts are unqualified, or displaying the real-time image of the assembly table and the instructions for assembly of the parts on the screen in response to determining the parts are qualified.

10. The medium as claimed in claim 9, wherein the sample image of a part comprises one or more projection views of the part.

11. The medium as claimed in claim 9, wherein the instructions for assembly of the parts comprise rules for assembling the parts, steps for assembling the parts, and indications for assembly locations of the parts in each step.

12. The medium as claimed in claim 9, wherein determining whether a part is qualified is achieved by determining if a profile of the part in the real-time image of the assembly table is same as a profile of the part in a sample image.
